(19) United States
(12) Patent Application Publication
(10) Pub. No.: US 2007/0065536 A1
(43) Pub. Date: Mar. 22, 2007

(54) Cooling device for molds in an injection molding machine

(76) Inventor: Ming-Yu Chen, Nan-Tou Hsien (TW)

Correspondence Address: G.LINK Co., LTD, 3550 Bell Road, MINOOKA, IL, 60447, US

(21) Appl. No.: 11/229,625

(22) Filed: Sep. 20, 2005

(51) Int. Cl. B29C 45/38

(52) U.S. Cl. 425/547

(57) ABSTRACT

A cooling device for molds in an injection molding machine includes a rotational cooling head, which is disposed in the male mold part. The cooling head provides a plurality of color mold sets with a shaft being disposed at an end of the center of the cooling head for being passed through with cooling liquid. The cooling head is driven by a gear with a rack to rotate the color mold sets. The liquid moves along the intake pipe and passages in the center of the cooling head for controlling circulation of the cooling liquid.

### BACKGROUND OF THE INVENTION

1. Field of the Invention

The present invention is related to a cooling device for molds in an injection molding machine and particularly to a rotational cooling device with multi-color mold sets to allow the injection molding machine capable of fabricating case shaped products and circular shaped products with high quality.

2. Brief Description of the Related Art

In order to prevent cooling pipeline from being tangled, the traditional injection molding machine is designed to be capable of reciprocally so that it only able to fabricate two-color products due to restriction of cooling pipeline arrangement in the mold.

The inventor has developed a cooling device for the injection molding machine being capable of fabricating product with three colors or more in Taiwanese Utility model Application No. 91204707.

However, the prior art has disadvantages to form certain shapes of products impossible to meet requirement of attractive appearance due to the cooling head existing deficiency in structure.

### SUMMARY OF THE INVENTION

An object of the present invention is to provide a cooling device for molds in an injection molding machine in which the cooling head thereof is driven more smoothly during rotating such that it is capable of fabricating circular shaped products perfectly and the cooling liquid intake and discharge ends is disposed at the center of the cooling head for less work and material loss.

Another object of the present invention is to provide a cooling device for molds in an injection molding machine in which the molds are attached to the cooling head directly instead of being disposed at periphery of the cooling head so that the molds are capable of fabricating case shaped products.

### BRIEF DESCRIPTION OF THE DRAWINGS

The detail structure, the applied principle, the function and the effectiveness of the present invention can be more fully understood with reference to the following description and accompanying drawings, in which:

FIG. 1 is a sectional view of the first embodiment of a cooling device for molds in an injection molding machine;

FIG. 2 is a side sectional view of the cooling head in the cooling device shown in FIG. 1;

FIG. 3 is a top view of the cooling head and the cooling device of the first embodiment shown in FIG. 1;

FIG. 4 is a plan view illustrating two-color mold sets in the first embodiment according to the present invention;

FIG. 5 is a plan view of illustrating three-color mold sets in first embodiment according to the present invention;

FIG. 6 is a sectional view of the second embodiment of a cooling device for molds in an injection molding machine according to the present invention; and

FIG. 7 is a sectional view illustrating the cooling head in the second embodiment shown in FIG. 6.

### DETAILED DESCRIPTION OF THE PREFERRED EMBODIMENTS

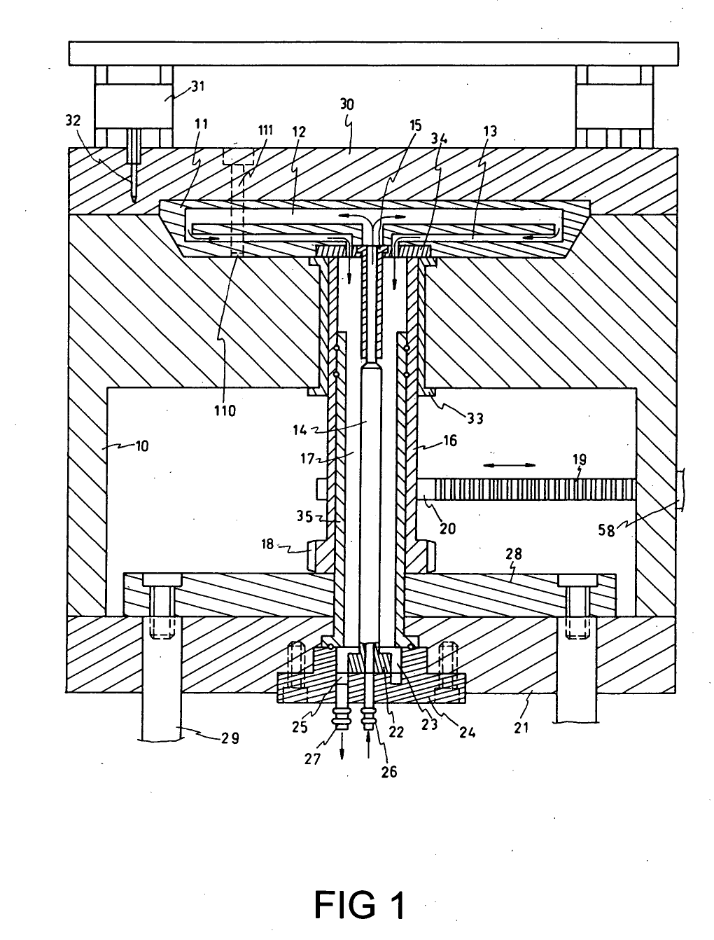

Referring to FIG. 1, the first preferred embodiment of a cooling device for molds in an injection molding machine according to the present invention provides a cooling head 11 at the center of the male mold part 10 and the cooling head 11 has a master passage 12 and a feed back passage 13. The master passage 12 connects with an intake pipe 14 at the central position thereof and the upper end of the intake pipe 14 slidably fits with a slide pipe 15. The slide pipe 15 is fixed to an end side of the cooling head 11 with a locating piece 34. Further, the intake pipe 14 is disposed in an inside pipe 35 and a passage 17 is formed in between. An axial shaft 16 is attached to the outer wall surface of the inside pipe 35 and the front end of the axial shaft 16 slidably fits with a bushing 33 to form a slide assembly in the male mold 10 for the axial shaft 16 rotating and moving more smoothly. The bushing 33 is joined to the end side of the cooling head 11. The rear end of the axial shaft 16 is provided with a gear 18 and a rack 19 is disposed at a lateral side of the axial shaft 16 near the gear 18 to drive the gear 18 such that the cooling head 11 can rotate with the axial shaft 16. A flat part 20 is provided at the front end of the rack 19 to avoid the gear 18 hitting the teeth on the rack 19. An extensive member 58 is disposed at another end of the rack 19 to move the rack 19 forward and backward.

A push plate 18 is disposed at the rear end of the gear 18 and the inner pipe 35 penetrates the center of the push plate 28. Both lateral sides of the push plate 18 have an extension member 29 respectively and the respective extension member 29 passes through a base 21 to be fixed to the injection molding machine. The push plate 28 is actuated with the extension members 29 to move the gear 18, the shaft 16 and the cooling head 11 displacing axially. Meanwhile, the slide pipe 15 is driven by the locating piece 34 to move axially too such that the intake pipe 14 allows the incoming water circulating along the master passage 12 and flowing back to the passage 17 via the feed back passage 13.

The inner pipe 35 with the rear end thereof penetrates into the central part of the base 21 and the rear end of the inner pipe 35 is joined to the base 21 with a locating block 24. The intake pipe 14 has a joint part 22 surrounded with a plurality of flow back holes 23 communicating with a plurality of flow back holes 25 in the locating block 24. The flow back holes 25 further connect with discharge connector 27 to discharge hot water flowing back via the passage 17. The intake pipe 14 connects with an intake connector 26 to admit cold water such that a cooling cycle is formed with discharge of the hot water.

A locating hole 110 is provided at the cooling head 11 and a pin 111 is provided at a female mold 30 corresponding to the locating hole 110. The male mold 10 and the female mold 30 are joined to each other by way of the pin 111 being inserted into the locating hole 110 to avoid improper joint of the molds such that it is capable of preventing product from being defective and the entire mold set from damage.

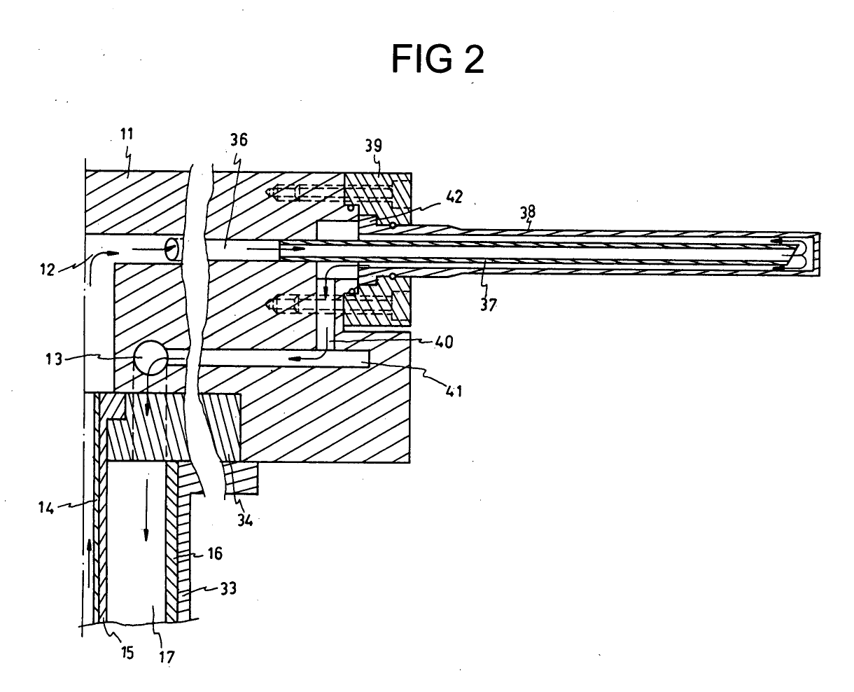

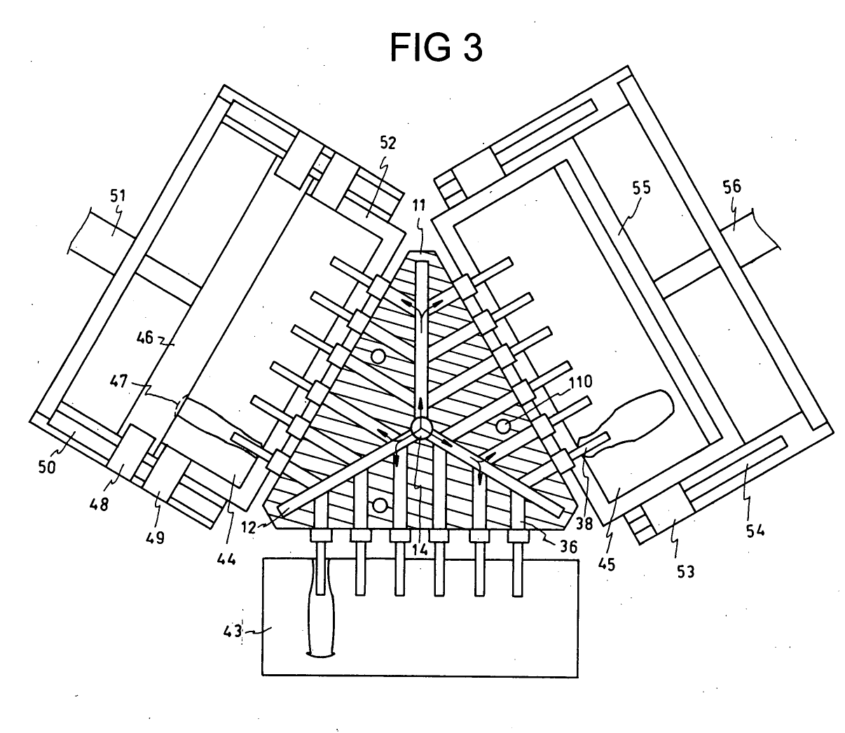

Referring to FIGS. 2 and 3 in company with FIG. 1, the female mold 30 is disposed above the male mold 10 and the cooling head 11 and a pouring passage 32 of the female mold 30 corresponds to a dividing plate 31. The number of the pouring passage 32 is equal to the number of the forming recess in the respective mold.

The cooling liquid enters the master passage 12 from the intake connector 26 via the intake pipe 14. Then, the master passage 12 distributes the cooling liquid into a branch passage 36 and a cooling pipe 37. Finally, the cooling liquid moves along space between the cooling pipe 37 and a locating shaft 38 to cool the locating shaft 38. The cooling liquid moves back via a communicating hole 40 and a branch back flowing hole 41 to enter the feed back passage 13. Then, the cooling liquid discharges via the discharge connector 27 after passing the passage 17 and the back flowing holes 23, 25.

Due to the locating shaft 38 being surrounded with plastic material filled in the mold recess in the process of injection molding and the cooling liquid continuously flowing into the locating shaft 38 circularly, the plastic material surrounding the locating shaft 38 is cooled speedily and the finished work can be released from mold rapidly after multiple color injection molding is complete. The deficiency of waiting for being cooled and getting into shape can be overcome.

In order to prevent from rotation or turning toward a specific direction caused by shape, the locating shaft 38 has a directional head with a shape of polygon or flange or an irregular shape at the front end thereof. The locating shaft 38 is inserted into a locating block 39 first and then assembled to the cooling head 11. In this way, not only the locating shaft 38 is renewed easily but also it can locate orientation of product, which needs to be considered the direction thereof, for preventing from defective product.

When the first color mold 43, the second color mold 44 and the third color mold 45 have completed injection molding, the female mold 30 is away from the male mold 10 and the extension members 29 moves with the push plate 28 to push the shaft 16 and allow the gear 18 moving to the rack 19. The extension member 28 moves the rack 19 to drive the gear 18 turning after the finished products are away the color molds synchronously and to let the cooling head 11 and the locating shaft 38 with finished product thereon moving to next color mold. The finished product with all the colors is released the mold completely. When the locating shaft 38 enters the first mold 43, the female mold 30 moves downward to push the cooling head 11 and retreat inside the male mold 10 such that the male mold 10 and the female mold 30 join again and the pin 111 is inserted into the locating hole 110 at the same time for the mold set in a state of being set up precisely. The shaft 16 is available for the cooling head 11 assembling with the cooling head 11 accurately to overcome the deficiency of clearance and offset resulting from operation of the radial shafts.

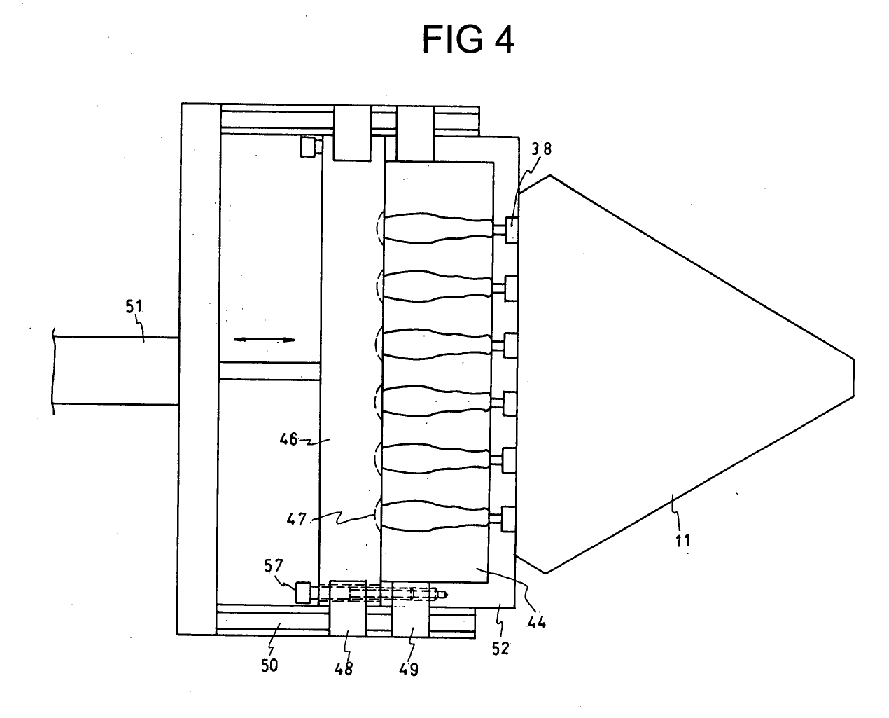

Referring to FIG. 4 in company with FIG. 3, the second color mold provides a tail mold 46 at the rear end thereof and the tail mold 46 has a push rod 52 at the front end thereof. The tail mold 46 and the push rod 52 have slide blocks 48, 49 at both lateral sides thereof and the slide blocks 48, 48 slide on a slide rail 50. The slide rail 50 has an extension part 51 at the rear end thereof to join with the tail mold 46 and the tail mold 46 is fastened to the rear end of the push rod 52 with a locating screw rod 57.

When the cooling head 11 and the work on the locating shaft 38 move upward, the second color mold 44 stays on the male mold 10 and the extension part 51 drives the tail mold 46 to move backward till touching the locating screw rod 57 such that the mold recess 47 of the tail mold 46 detaches from the work on the locating shaft 38 and the push rod 52, which is joined to the locating screw rod 57, is driven by the locating screw rod 57 to move backward secondly and allow the work on the locating shaft 38 slightly withdrawing a proper distance. Meanwhile, the push rod 52, tail mold 46, slide rail 50 and the extension part 51 descend and the cooling head 11 and the work are actuated to rotationally enter the third color mold 45 with the front end of the work moving back a distance in the mold recess of the third color mold 45 for the third color plastic material being injected at the front end of the work and forming the third color. Hence, the first color mold 43, the second color mold 44 and the third color mold 45 perform injection, retreating mold and releasing mold sequentially by way of circular circulation respectively.

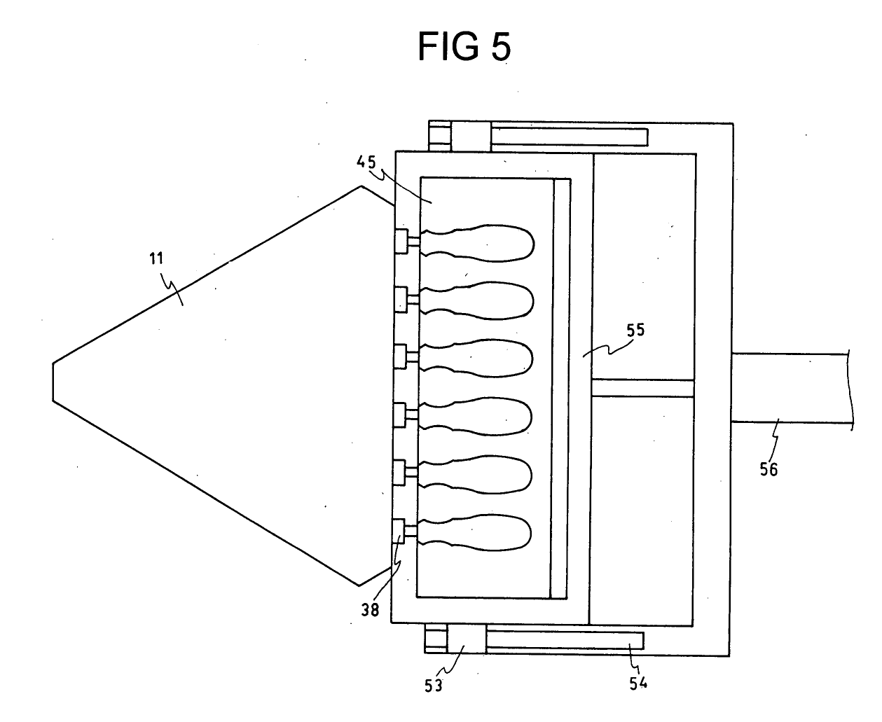

Referring to FIG. 5, the third color mold 45 has a push rod 55 at the outer side thereof and two lateral sides of the push rod 55 has a slide rail 54 with slide block 53 joined to the push rod 55. The push rod 55 is driven by an extension element 56 to move along the slide rail 54 such that the work is pushed by the push rod 55 being away the locating shaft 38 to perform releasing mold.

The preceding cooling system for the forming mold has the cooling head 11 lifts to allow the work separating from the first, second and third molds 43, 44, 45 respectively during the plastic material being filled in the mold recesses of the color molds 43, 44, 45 and the push rod 52 partly retreats the work on the locating shaft 38. Synchronously, the push rod 55 completely withdraws the work from the locating shaft 38 to perform releasing mold. Then, the cooling head 11 turned again to let the locating shaft 38 rotating to the first color mold 43 after releasing mold and works at the original first and second color molds 43, 44 moves into the second and third color molds 43, 44 respectively before the female mold 30 lowers to press the cooling head 11 into the male mold 10 and the pin 111 is inserted into the locating hole 110 to correct the mold set in a state of joining to each other precisely for performing injection molding.

As the foregoing, due to improvement on the arrangement with regard to the shaft of the cooling pan, the intake and discharge water and the locating shaft, it is capable of stabilizing precision of movement and assembly between the cooling head and the mold set. The cooling pipe is disposed at the central position to lessen shortcoming resulting from the pipeline tangling outside the injection molding machine. Improvement of the locating shaft enhances steady product quality and makes the locating shaft being renewed easily.

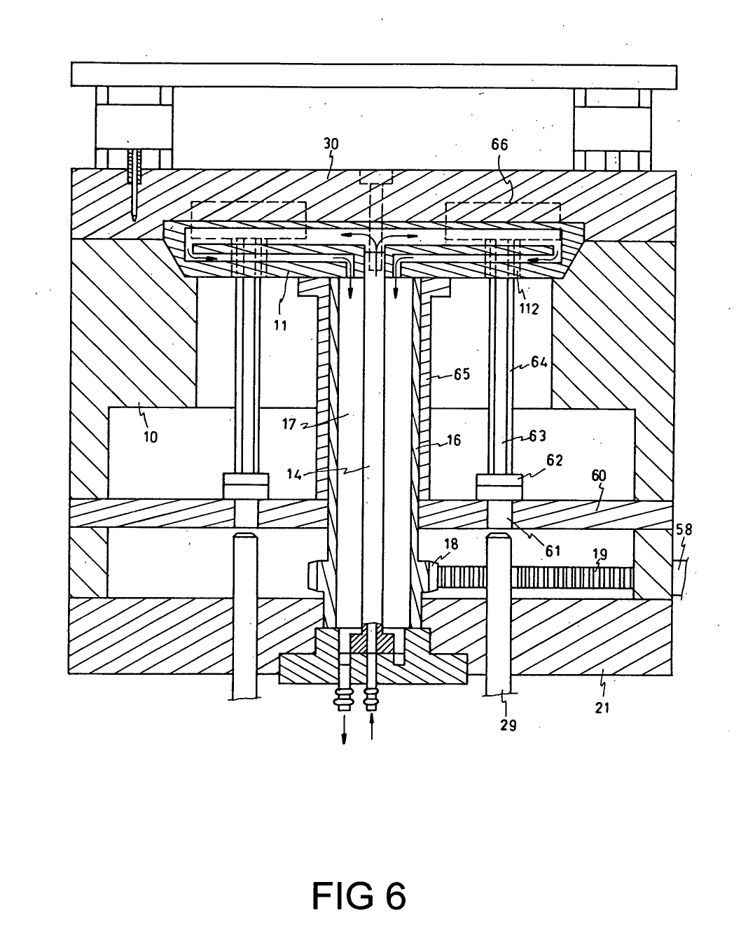

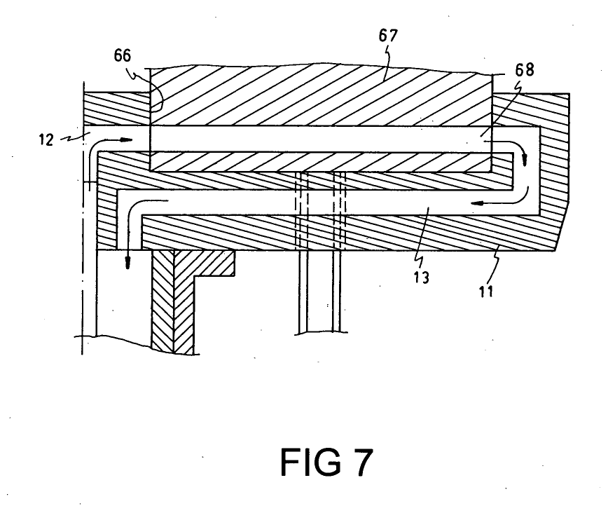

Referring to FIGS. 6 and 7, another embodiment of cooling device for molds in an injection molding machine according to the present invention is used for case type plastic product. Great difference of the present embodiment from the first embodiment, which is used for small size circular product, is in that the mold set is disposed on the cooling head 11 instead of surrounding the cooling head 11 and the cooing head 11 rotates without lifting and only the mold set and the work lift. A partition 60 is disposed between the male mold 10 and the base 21 and through holes 61 are provided for being passed through with the extension members 29 from an end thereof respectively. A push plate 62 is disposed at another end of each of the through holes 61 and a push rod 63 and a guide rod 64 are fixedly attached to the push plate 62 respectively. The cooling head 11 has through holes for being passed through the push rod 63 respectively. The gear 18 and the rack 19 are disposed between the partition 60 and the base 21 and the shaft 16 passes through the partition 60 to be fixedly attached to the cooling head 11. A bushing 65 is mounted to the shaft 16 at the section thereof between the partition 60 and the cooling head 11. Further, the cooling head 11 has a mold recess 66 with a forming mold 67 and the forming mold 67 has heat dissipation passage 68 communicating with the master passage 12 and the feed back passage 13. The shaft 16 provides an intake pipe 14 so as to form a passage 17 in the shaft 16.

The extension member 29 pushes the push plates 62 via the passing hole 61 to actuate the push rod 63 and the guide rod 64 moving after the plastic material moves. The push rod 63 pushes the forming mold 67 and the work and as the preceding, the finish work is pushed out to perform operation of releasing mold as the preceding. The unfinished work or single color work is partly withdrawn to separate from the pour opening for the plastic material or reserve a coating distance for attaching subsequent color.

While the invention has been described with referencing to preferred embodiments thereof, it is to be understood that modifications or variations may be easily made without departing from the spirit of this invention, which is defined by the appended claims.

What is claimed is:

1. A cooling device for multi-color injection molds, comprising:
a male mold, providing a cooling head at the center thereof; and
a female mold, being joined to the male mold;
wherein, the cooling head is surrounded with a plurality of color mold sets and a shaft is provided at an end of the center of the cooling head for being passed through with cooling liquid, a bushing is disposed in the male mold to fit with the outer surface of the shaft, another end of the cooling head has a gear with a rack at a lateral side thereof, a base is attached to an end of the shaft, a push plate is disposed between the gear and the base, an inner pipe is in the shaft joined to the base, an intake pipe is disposed in the inner pipe with a feed back passage being between the intake pipe and the inner pipe, another end of the base has an intake connector and a discharge connector to communicate with the intake pipe and the passage respectively for controlling circulation of the cooling liquid.

2. The cooling device for multi-color injection molds as defined in claim 1, wherein the cooling head is attached with a slide pipe to communicate with the intake pipe, a plurality of branch passage are provided along a master passage with each of the branch passage being joined to the cooling pipe, a locating shaft is disposed to surround the cooling pipe with a communication hole there between to communicate with a branch flow back passage, the feed back passage and passage.

3. The cooling device for multi-color injection molds as defined in claim 2, wherein the slide pipe is attached to the cooling head with a locating piece.

4. The cooling device for multi-color injection molds as defined in claim 1, wherein the intake pipe has a joint with a first flow back hole being joined to the base by a locating block and the locating block has a second flow back hole communicating a discharge connector and has an intake connector at the central position thereof communicating with the intake pipe.

5. The cooling device for multi-color injection molds as defined in claim 1, wherein the rack has a flat part at the front end thereof.

6. The cooling device for multi-color injection molds as defined in claim 1, wherein the cooling head has a locating hole for being inserted with a pin to locate the female mold.

7. The cooling device for multi-color injection molds as defined in claim 2, wherein the cooling head has a locating hole for being inserted with a pin to locate the female mold.

8. The cooling device for multi-color injection molds as defined in claim 1, wherein each of color mold sets except the first color mold thereof has a push rod facing the cooling pan.

9. The cooling device for multi-color injection molds as defined in claim 8, wherein the push rod is joined to the respective color mold with a slide block and the slide block is disposed on a slide rail.

10. The cooling device for multi-color injection molds as defined in claim 8, wherein the respective color mold has a tail mold at the rear end thereof and the respective color mold with the tail mold is joined to the push rod by the slide block.

11. A cooling device for multi-color injection molds, comprising:
a male mold, providing a cooling head at the center thereof; and
a female mold, being joined to the male mold;
wherein, the cooling head is provided with a plurality of mold recesses for receiving a plurality of color mold sets and a shaft is provided at an end of the center of the cooling head for being passed through with cooling liquid, a bushing fits with the outer surface of the shaft, an end of the bushing contacts with an end face of a partition, an end of the shaft passes through the partition and attaches with a gear, a lateral side of the gear has a rack, a base is attached to an end face of the shaft, an inner pipe is in the shaft joined to the base, an intake pipe is disposed in the inner pipe with a feed back passage being between the intake pipe and the shaft connecting with a discharge connector at another end of the base, the intake pipe has a joint at an end thereof being joined to the base to connect an intake connector for controlling circulation of the cooling liquid; and the partition has through holes for being passed through with an extension member respectively with an end of the respective through hole attached with a push plate and the push plate has a guide rod and a push rod capable of inserting into the cooling head to push the respective color mold set and a formed work therein.

12. The cooling device for multi-color injection molds as defined in claim 11, wherein the cooling head communicates an intake pipe to communicate the master passage, the feed back passage and the passage.

13. The cooling device for multi-color injection molds as defined in claim 11, wherein the mold sets provide a hot passage to communicate with the master passage and the feed back passage.

14. The cooling device for multi-color injection molds as defined in claim 12, wherein the mold sets provide a hot passage to communicate with the master passage and the feed back passage.

15. The cooling device for multi-color injection molds as defined in claim 12, wherein the joint of the intake pipe with a first flow back hole is joined to the base with a locating block and the locating block has a second flow back hole communicating a discharge connector and has an intake connector at the central position thereof communicating with the intake pipe.

16. The cooling device for multi-color injection molds as defined in claim 11, wherein the cooling head has a locating hole for being inserted with a pin to locate the female mold.

17. The cooling device for multi-color injection molds as defined in claim 12, wherein the cooling head has a locating hole for being inserted with a pin to locate the female mold.

18. The cooling device for multi-color injection molds as defined in claim 1, wherein the cooling device is for fabricating injection molded product with two or more colors.

19. The cooling device for multi-color injection molds as defined in claim 11, wherein the cooling device is for fabricating injection molded product with two or more colors.
